(19) United States
(12) Patent Application Publication
(10) Pub. No.: US 2002/0147991 A1
(43) Pub. Date: Oct. 10, 2002

(54) Transmission of panoramic video via existing video infrastructure

(76) Inventors: John L. W. Furlan, Belmont, CA (US); Derek Fluker, San Jose, CA (US); Robert G. Hoffman, Fremont, CA (US)

Correspondence Address: BE HERE CORPORATION, 20300 STEVENS CREEK BLVD, SUITE 100B, CUPERTINO, CA, 95014-2241, US

(21) Appl. No.: 09/835,617

(22) Filed: Apr. 10, 2001

(51) Int. Cl. H04N 7/16; H04N 7/18; H04N 7/12

(52) U.S. Cl. 725/135; 375/240.03; 348/42

(57) ABSTRACT

Technology is disclosed that allows an immersive video to be transmitted from a first site to a second site using standard television infrastructure. Each frame of the immersive video is packed into at least one standard television frame. The standard television frame is suitable for transmission using standard television infrastructure. Once the standard television frame is received at the second site, the immersive video frame is reconstructed. The reconstructed immersive video frame can then be transmitted, recorded, viewed, or used to generate a view for transmission or recording.

### BACKGROUND OF THE INVENTION

1. Field of the Invention

This invention relates to the field of video signal transmission.

2. Background

Existing television infrastructure provides a means for capturing television video at a remote site (for example, using a remote unit), transferring the television video to an intermediate site (for example, a broadcast studio) for transmission to receiver sites (via broadcast, cable, satellite, Internet, or similar technology).

Standard television video comprises interlaced lines of image information that combine to produce the visual effect of motion. Existing television infrastructure defines a frame composed of two fields of lines to effectuate the interlacing of lines in the frame. Television video presents a view of a scene that is captured by a video camera. The view of the scene captured by the camera it is a function of the lens on the camera and the direction that the camera is pointed into the scene.

Immersive video comprises a stream of frames that allows a viewer to specify the view into the scene that is to be presented. An immersive video stream comprises a sequence of frames containing a wide-angle image of the scene (in some cases 360-degrees surrounding the lens, in other cases from a wide-angle lens such as 150-degree lens or a fish-eye lens). The immersive video stream contains information beyond that provided by a normal view into the scene. Thus, a viewer can select which portion of the immersive video to view. There are a number of camera/lens technologies that capture immersive video frames. These include technologies that use a lens to capture an annular image of the scene around the lens, and those that use two or more wide-angle (often fisheye) lenses to capture hemispherical views of the scene around the lenses. The multiple-lens technologies gather light that can be received by multiple cameras (or in some cases, by a single camera receiving images through both of the lenses). These technologies all capture warped images of the scene. Once the viewer specifies the viewpoint into the scene, the portion of the warped images that correspond to the view must be unwarped to present the undistorted view desired by the viewer.

Frames in immersive video streams do not have the same characteristics as standard television video. For example, an immersive video camera with a catadioptric lens that gathers light from 45 degrees above and below the horizon line has an aspect ratio of 4: 1, that represents a 360-degree wide by 90-degree tall panorama (the aspect ratio will be 3.4:1 if the gathered light is from 45-degrees above and 60-degrees below the horizon line). Standard television video frames have an aspect ratio of 4:3 and consist of 640 by 480 pixels for the NTSC format and 704 by 512 for the PAL format. Another difference is that the amount of image data in a frame of an immersive video stream is much larger than the data in a standard frame of video. Immersive video frames generally are not interlaced (although they could be).

Immersive videos are currently sent across the Internet and generally are compressed for transmission using a compression/decompression mechanism (codec). The immersive video is stored on a server and made available to viewers on a network (such as a computer network, the Internet, or possible future broadcast networks).

One problem with providing live immersive video is that the immersive video is often captured at a site that is not local to a broadcast station or server farm. Thus, the live immersive video needs to be delivered to the broadcast station and/or server farm. The existing television infrastructure does not provide a cost effective way to deliver “live” immersive video from a remote site.

Traditionally, a remote television video stream is gathered by a remote unit at the camera/news/sport/event site, transmitted to a television studio where it is edited, possibly recorded, and then transmitted for viewing at receiver sites. The remote units are able to send standard television video to the television studio by using cable, microwave links, satellite, or other currently existing television infrastructure. In addition, the standard television video stream can be compressed (by a codec) for delivery over a network and the compressed video (or group of videos compressed for different bandwidth utilization) sent to a server farm for delivery to clients.

One way to send an immersive video from the remote site is to have it compressed by a codec at the remote unit so that the data in the immersive frame fits within a television video frame. This requires a codec at each remote unit and one at the studio. Codecs that can process the frame rate and resolution required by immersive video are expensive (either in hardware cost or in the computer capability required to execute a software codec at video rates). Currently, remote units generally do not include such codecs. Thus, adding such a codec to the remote unit (for example, in each roving television station van) increases the cost of the remote unit. In addition, because the images captured through the camera/lens are generally not rectangular (usually circular, multiple circular, or annular) standard compression algorithms used by the codecs are not as efficient as if the image were rectangular.

U.S. Pat. No. 5,280,540, Video Teleconferencing Systems Employing Aspect Ratio Transformation, dated Jan. 18, 1994 by Addeo et al. teaches means for transmitting 16:9 aspect ratio image using a 4:3 aspect ratio transmission frame. However, Addeo does not teach or suggest the problems addressed by the current invention nor the approach taken by the inventors to solve these problems.

Because immersive video does not have the same characteristics as standard television video, existing television infrastructure is not well suited for transmitting immersive video from a remote unit to the broadcast station.

It would be advantageous to be able to format the immersive video stream within a standard video stream so that existing and future television infrastructure/technology can be used to send an immersive video stream to a designated site where the immersive video can be converted into a deliverable form (for example, by broadcast or Internet service).

### SUMMARY OF THE INVENTION

The problems associated with sending an immersive video using existing television infrastructure are addressed by aspects of the inventions disclosed herein. In one preferred embodiment, an immersive video is acquired at a first location, packed into one or more standard television frames and sent to a second location using standard television infrastructure.

Another preferred embodiment receives at least one standard television video frame that contains an immersive video frame, unwarps a portion of the immersive video frame into a view and presents the view.

Yet another preferred embodiment includes the steps of acquiring an immersive video frame, packing the immersive video frame into at least one standard television video frame that is sent to a second location using television infrastructure to be received at a television receiver where a portion of the immersive video frame within the standard television video frame is unwarped into a view and presented.

Still other preferred embodiments include apparatus for sending and/or receiving such immersive videos using television infrastructure, and of systems for doing the same.

In addition, another preferred embodiment is of computer program products that cause a computer to perform the operations of these and similar apparatus and systems.

The foregoing and many other aspects of the present invention will no doubt become obvious to those of ordinary skill in the art after having read the following detailed description of the preferred embodiments that are illustrated in the various drawing figures.

### DESCRIPTION OF THE DRAWINGS

FIG. 1 illustrates a field of view of a catadioptric lens in accordance with a preferred embodiment;

FIG. 2A illustrates an annular image that represents the field of view of FIG. 1;

FIG. 2B illustrates a panoramic representation of the annular image of FIG. 2A having an aspect ratio of 4:1;

FIG. 2C illustrates a panoramic representation of the annular image of FIG. 2A having an aspect ratio of 3.4:1;

FIG. 2D illustrates a real world three-dimensional environment including a warped circular image resulting from a wide-angle lens in accordance with a preferred embodiment;

FIG. 2E illustrates a frame containing dual hemispherical images of a scene in accordance with a preferred embodiment;

FIG. 2F illustrates a frame containing a projection resulting from the dual hemispherical images of FIG. 2E in accordance with a preferred embodiment;

FIG. 3 illustrates an immersive video transmission architecture in accordance with a preferred embodiment;

FIG. 4A illustrates a first packing of a 4:1 warped representation in accordance with a preferred embodiment;

FIG. 4B illustrates a second packing of a 4:1 warped representation in accordance with a preferred embodiment;

FIG. 4C illustrates a first packing of a 3.4:1 warped representation in accordance with a preferred embodiment;

FIG. 4D illustrates a second packing of a 3.4:1 warped representation in accordance with a preferred embodiment;

FIG. 4E illustrates a split-frame packing of a warped representation in accordance with a preferred embodiment;

FIG. 4F illustrates a packing of dual scaled hemispherical images in accordance with a preferred embodiment;

FIG. 4G illustrates a split-frame packing of a dual hemispherical image in accordance with a preferred embodiment;

FIG. 4H illustrates truncated packing of an hemispherical image in accordance with a preferred embodiment;

FIG. 5 illustrates an immersive video transmission process in accordance with a preferred embodiment;

FIG. 6 illustrates an immersive video receiver process in accordance with a preferred embodiment;

FIG. 7 illustrates a second immersive video transmission process in accordance with a preferred embodiment;

FIG. 8 illustrates a second immersive video receiver process in accordance with a preferred embodiment; and

FIG. 9 illustrates a viewing process in accordance with a preferred embodiment.

### DESCRIPTION OF THE PREFERRED EMBODIMENTS

Notations and Nomenclature

The following ‘notations and nomenclature’ are provided to assist in the understanding of the present invention and the preferred embodiments thereof.

Procedure—A procedure is a self-consistent sequence of computerized steps that lead to a desired result. These steps are defined by one or more computer instructions. These steps can be performed by a computer executing the instructions that define the steps. Thus, the term “procedure” can refer (for example, but without limitation) to a sequence of instructions, a sequence of instructions organized within a programmed-procedure or programmed-function, or a sequence of instructions organized within programmed-processes executing in one or more computers. Such a procedure can also be implemented directly in circuitry that performs the required steps.

Description

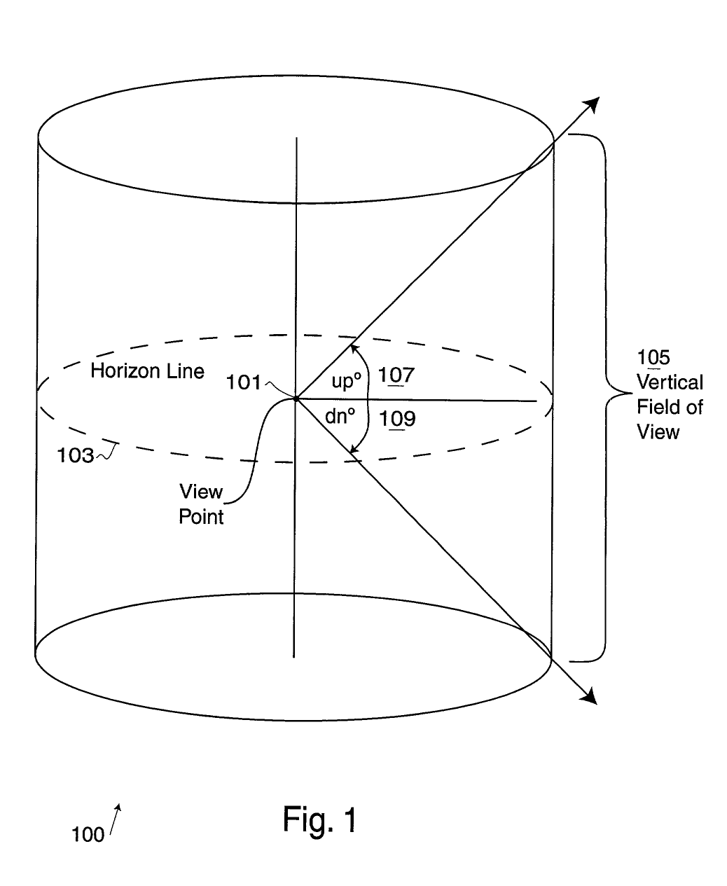

FIG. 1 illustrates a field of view 100 captured by a catadioptric lens attached to a camera. All light intersecting a viewpoint 101 is captured on either side of an horizon line 103 for a substantially 360-degree band-of-light within a vertical field of view 105 defined by a first angle 107 above the horizon line 103 and a second angle 109 below the horizon line 103. The first angle 107 and the second angle 109 need not (but can) have the same value (for example both angles being 45-degrees or the first angle 107 being 45-degrees and the second angle 109 being 60-degrees.

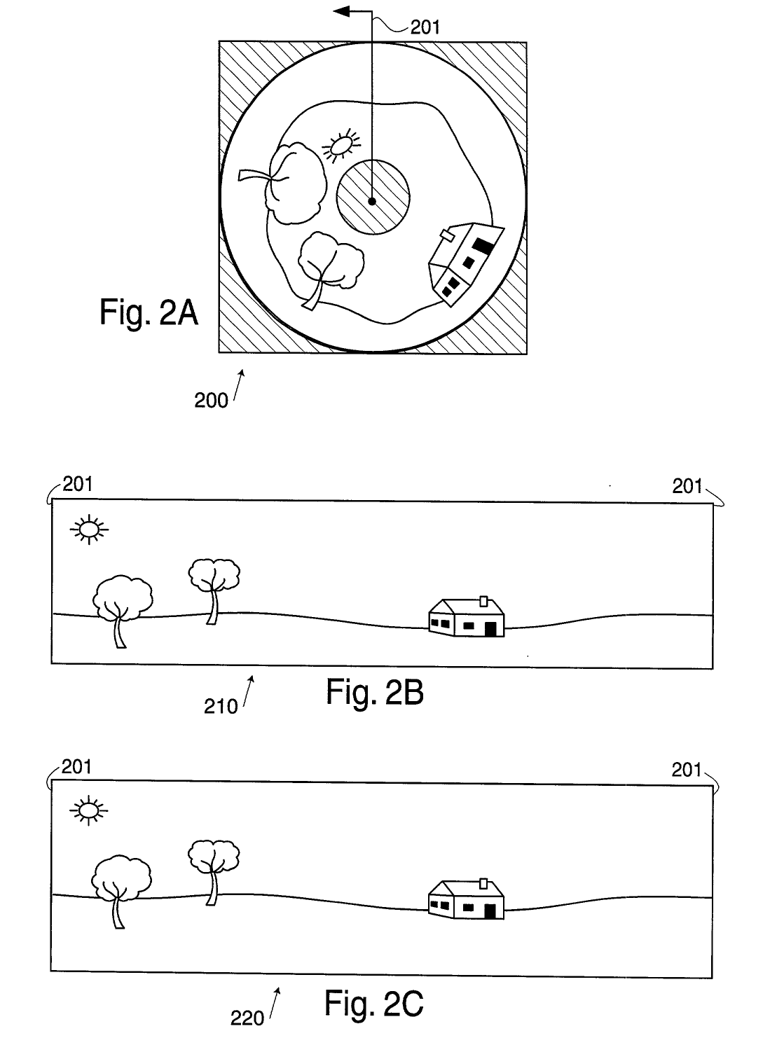

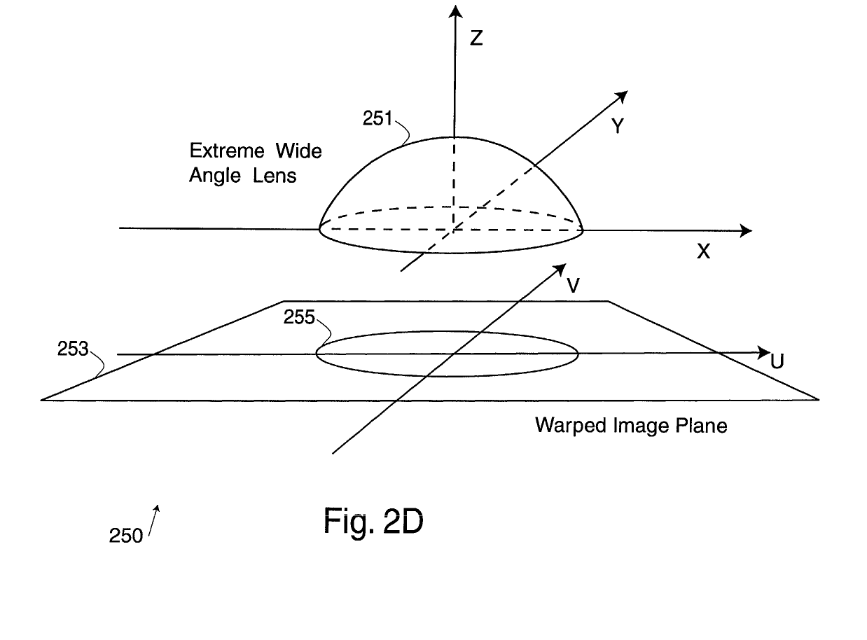

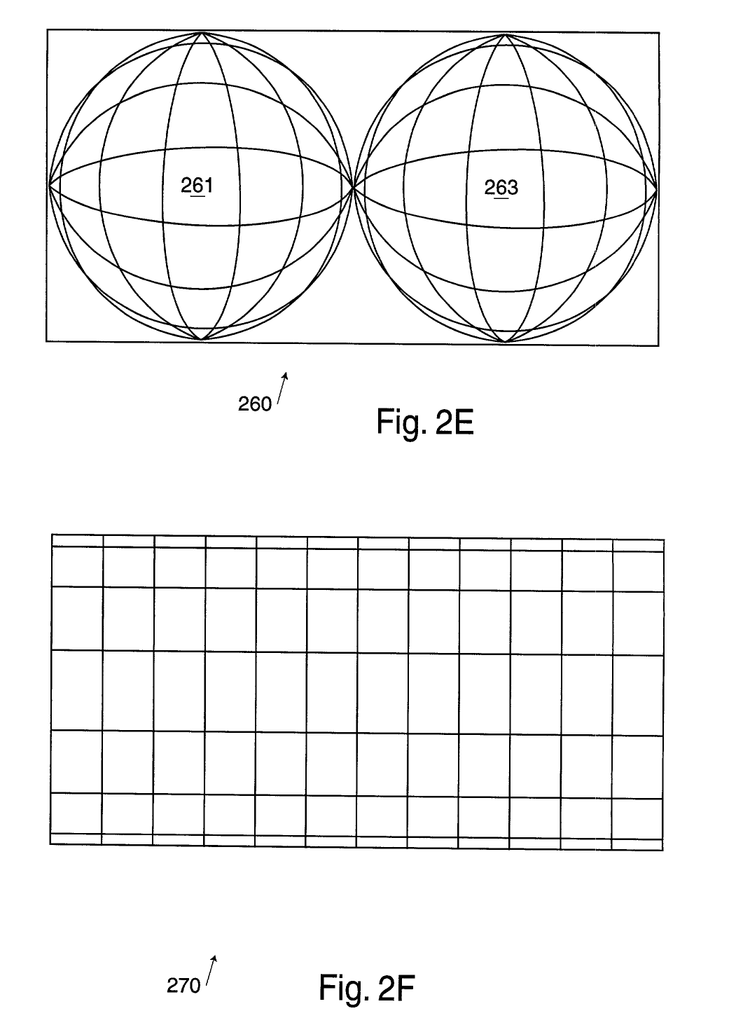

FIG. 2A illustrates an annular image 200 that represents the field of view 100 of a catadioptric lens. The annular image 200 can be unwrapped by designating an edge 201 and mapping the annular image 200 into a panorama.

FIG. 2B illustrates a panoramic image 210, that results from unwrapping the annular image 200 of FIG. 2A, and that has an aspect ratio of 4:1. The 4:1 aspect ratio results from the first angle 107 and the second angle 109 each having a value of 45-degrees.

FIG. 2C illustrates a panoramic image 220 that has an aspect ratio of 3.4:1 that results from the first angle 107 having a value of 45-degrees and the second angle 109 having a value of 60-degrees.

The aspect ratio of the panoramic band of light captured by a catadioptric lens is determined by comparing the vertical field of view 105 with 360-degrees. Thus, if the first angle 107 and the second angle 109 were both 45-degrees the aspect ratio would be 4:1. However, if the first angle 107 was 45-degrees and the second angle 109 was 60-degrees the aspect ratio would be 3.4:1.

FIG. 2D illustrates a real world three-dimensional environment 250 that has been imaged by a wide-angle lens 251. The real world three-dimensional environment 250 can be defined by the Cartesian coordinate system in X, Y and Z with the viewpoint defined to be the origin of the coordinate system. One skilled in the art will understand that the real world three-dimensional environment 250 can also be defined using spherical or cylindrical or other coordinate systems. The viewing direction of the user, as determined from the user's input, can be given as a viewing vector in the appropriate coordinate system. An image plane 253 containing a warped wide-angle image 255 can be defined by a two dimensional coordinate system in U and V, with the origin of the coordinate system coincident with the origin of the X-Y-Z coordinate system. If the field of view of the wide-angle lens 251 is sufficient, and the lens is rotationally symmetric about the viewing axis, the warped wide-angle image 255 will be substantially circular in the U-V plane.

FIG. 2E illustrates a frame of hemispherical images 260 that contains a first hemispherical image 261 and a second hemispherical image 263. Each of the hemispherical images result from capturing a substantially back-to-back 180-degree field of view through a very-wide-angle lens (for example a fish-eye lens) such that both hemispheres, when combined, provide a 360-degree by 180-degree image. A camera system capable of capturing the frame of hemispherical images 260 is described in U.S. Pat. No. 6,002,430, Method and Apparatus for Simultaneous Capture of a Spherical Image. Another arrangement for capturing a 360-degree image is described in U.S. Pat. No. 5,796,426, Wide-Angle Image Dewarping Method and Apparatus.

FIG. 2F illustrates a rectangular representation 270 that shows one result of mapping two hemispherical images such as shown in FIG. 2E onto a full panoramic image having an aspect ratio of 2:1. For a full panorama, the opposite edges of the rectangular representation connect.

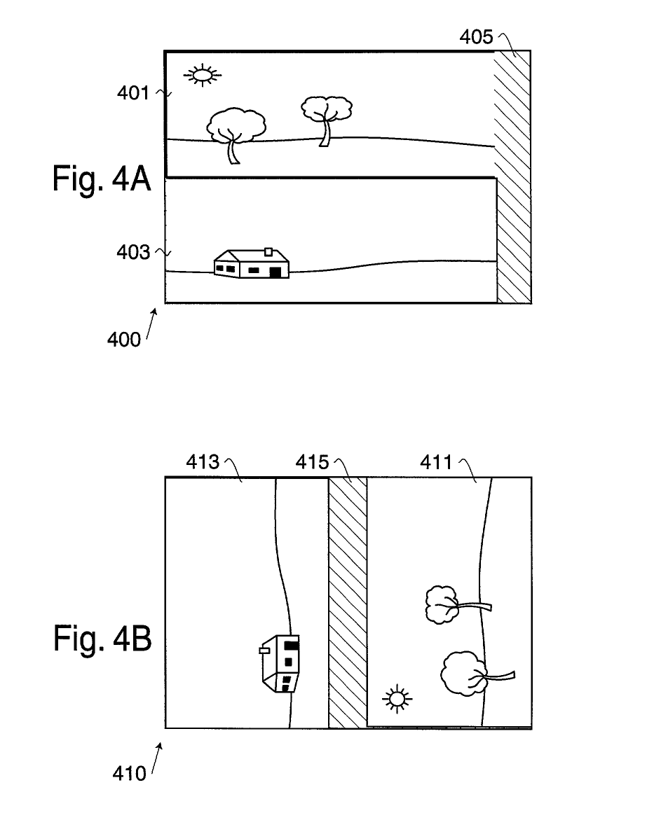

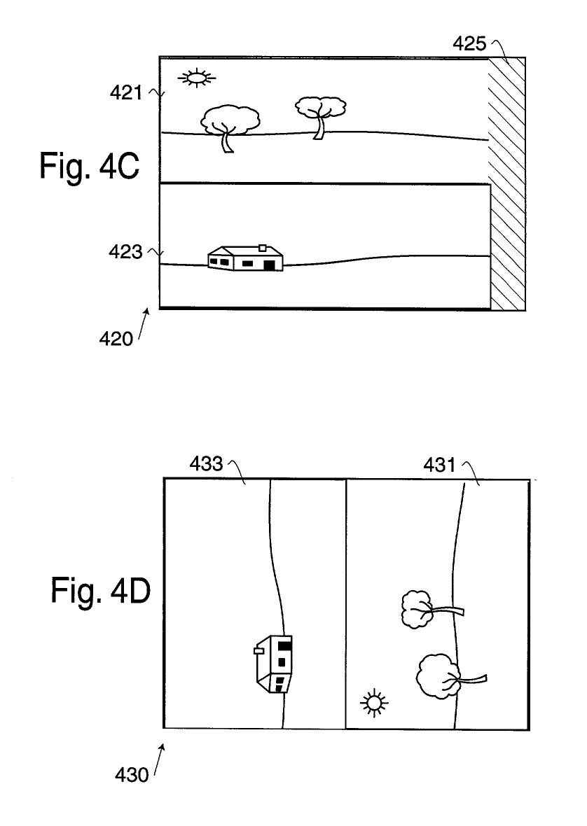

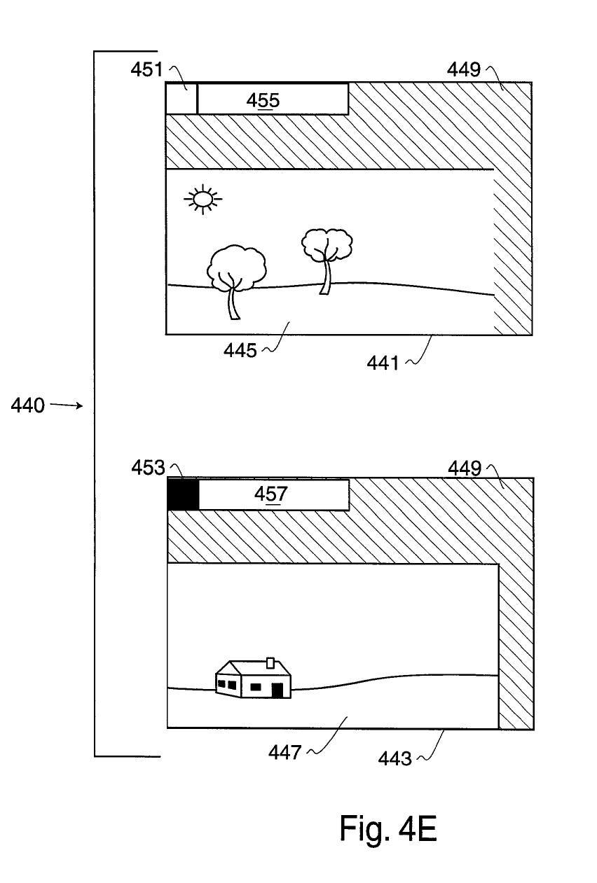

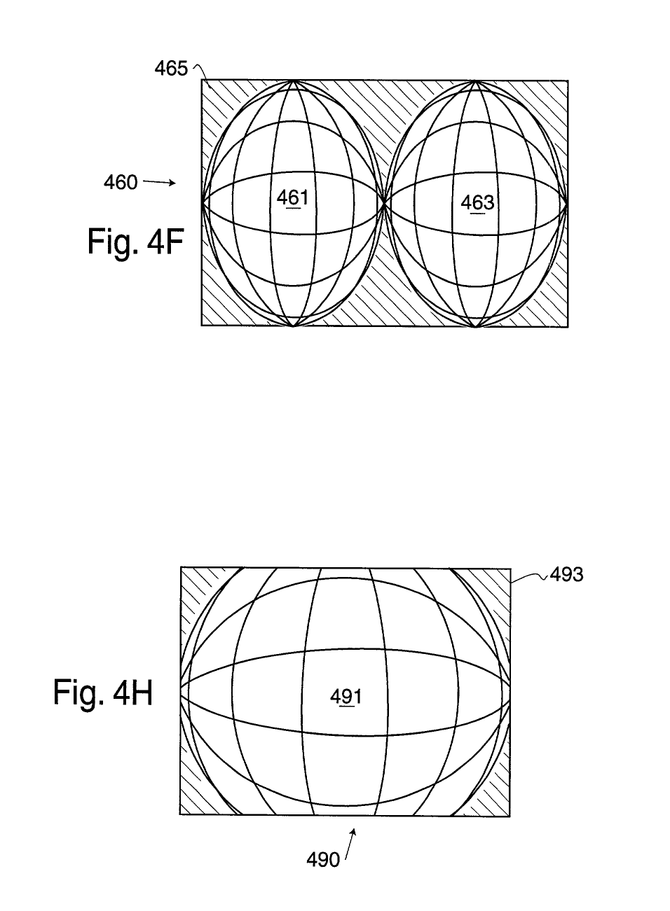

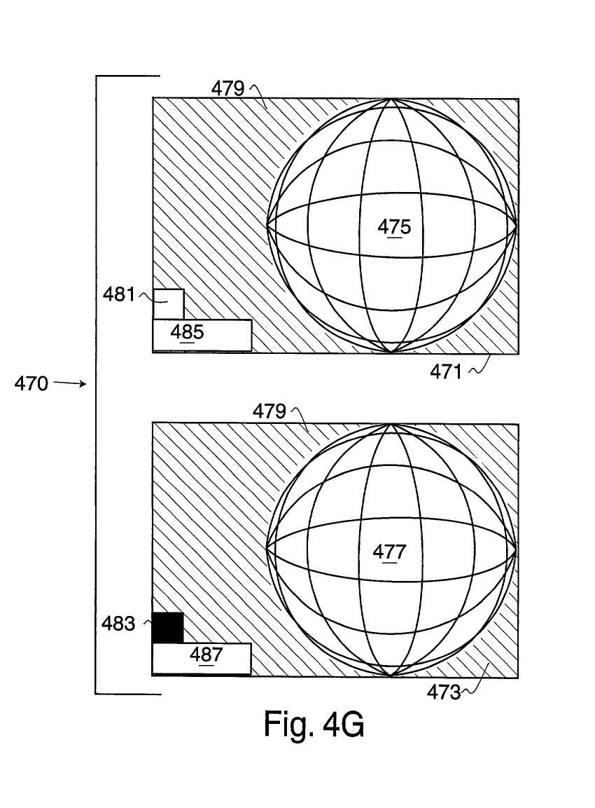

Some of these immersive video frames provide enough information to create a complete 360-degree by 180-degree panorama or a 360-degree by 90-degree panorama. Others provide enough information for a partial panorama (for example, the frame shown in FIG. 4H).

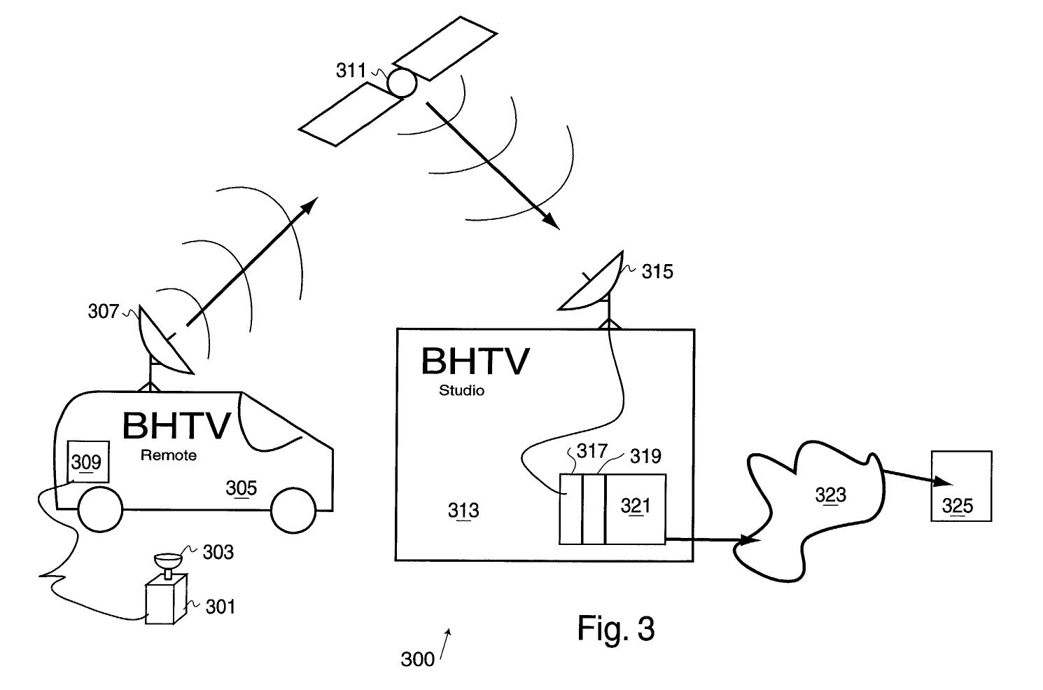

FIG. 3 illustrates an immersive video transmission architecture 300 used to transmit immersive videos of a scene taken by a video camera 301 equipped with a warping lens 303. Each of the immersive video frames from the video camera 301 contains a warped representation of the scene around the warping lens 303. Each frame acquired from the video camera 301 is communicated to a remote broadcast unit 305 by either wire or a wireless communication channel. The remote broadcast unit 305 can be equipped with a communications link 307 (for example, but without limitation a satellite link, a microwave link, or any other television signal transmission mechanism). One skilled in the art will understand that the immersive video can be gathered (for example, but without limitation) by a digital video camera, an analog video camera in communication with a digitizer, a video playback device, or a computer.

The warping lens 303 can be one or more wide-angle lenses (including fish-eye lenses and rectilinear lenses) and/or one or more catadioptric lens.

The warped representation of the scene that results when the warping lens 303 is a catadioptric lens is a complete or partial annular image. Other types of lenses produce warped representations having characteristics particular to the lens type. For example, a fish-eye lens produces a circular representation of a hemispherical portion of the scene. A wide-angle lens is another lens that will produce a warped representation. In addition, a rectilinear wide-angle lens can be used to capture a perspective-corrected image of the scene that is less warped.

In the remote broadcast unit 305, each frame of the immersive video is processed by a video processing device 309 to map the warped image (such as by unwrapping the annular image 200) into at least one standard television video frame. This standard television video frame is then sent using the television signal transmission mechanism. FIG. 3 for example, illustrates a satellite communication system where the signal is first sent to a satellite 311 that re-transmits the signal to a broadcast facility 313 where it is received by a television signal receiver mechanism 315 that is connected to a computer 317. Once the standard television video frame is received, the computer 317 can use a codec 319 to compress the immersive video frames into compressed frames for storage on a server computer 321. The server computer 321 can then make the immersive video available for streaming.

One skilled in the art will understand that the codec 319 is optional and that raw uncompressed video is often provided. Where the codec 319 is used, it can compress frames independently (such as a JPEG compression) and/or compress the frames for video streaming (such as an MPEG compression). Finally, such a one will understand that the codec 319 can be embodied as a specialized hardware device and/or as a computer executing codec software.

The server computer 321 can be connected to a computer network 323 (such as the Internet) and serves information from the stored frames (for example, compressed frames) to a client device 325. The client device 325 unwarps a portion of each frame it receives to present a viewer-designated view (for example, in real-time through a computer monitor or television set, by recording the view on a video tape, a disk or optical film, or on paper). In some embodiments, the client device 325 sends viewpoint information to the server computer 321 so that the server computer 321 will generate the view and send the view to the client device 325 for presentation (or to provide bandwidth management such as described by U.S. patent application No. 09/131,186). The server computer 321 can also provide the compressed frames over a broadcast, cable, satellite, or other network for receipt by the client device 325.

In another preferred embodiment, once the broadcast facility 313 receives the video from the remote broadcast unit 305, the video can be compressed one or more ways by a streaming video encoder, (for example, RealProducer or Windows Media Encoder). The video can be compressed by different amounts to target a particular bandwidth required for streaming the video. The compressed video streams can then by provided to users by the broadcast facility 313 or provided to a server farm to make the video streams available.

In yet another preferred embodiment, a director or cameraperson at the broadcast facility 313 can use a computer to select a view from the immersive video and broadcast that selected view to television receivers (either as the primary picture or as a picture-in-picture view).

The client device 325 can be a client computer, a television receiver, a video conferencing receiver, a personal organizer, an entertainment system, a set-top-box, or other device capable of generating a view from the compressed frames received over a network such as the computer network 323 or other transmission mechanism such as a microwave link, a television cable system, a direct subscriber line (DSL) system, a satellite communication system, a fiber communication system, an Internet, a digital television system, an analog television system, a wire system, or a wireless system.

In another preferred embodiment, the standard television video frame is a high definition television (HDTV) video frame and the television infrastructure is capable of supporting HDTV transmission and reception.

Thus, an immersive video frame captured in real-time can be captured at a remote site, packed into a standard television video frame and transmitted to the broadcast facility 313 using existing television transmission infrastructure. The central site can then reconstruct the immersive video, compress the immersive video, make it available over a network, and/or select a view into the immersive video and broadcast the selected view. In addition, the compressed immersive video can be broadcast to a set-top-box for processing by the set-top-box to allow a viewer to select his or her own view.

FIG. 4A through FIG. 4E illustrate some of the ways an immersive video frame can be packed into at least one standard television video frame. FIG. 4A illustrates one way a warped representation (for example, a panoramic image having an aspect ratio of 4:1 captured by a catadioptric lens) can be apportioned to fit within a standard television video frame 400. In this example, when each half of the panoramic image is transformed into the standard television video frame 400, the transformation process also scales the vertical dimension of each half of the panoramic image so that both halves of the panoramic image (a first 180-degree scaled portion of the panoramic image 401 and a second 180-degree scaled portion of the panoramic image 403) can be stored in the standard television video frame 400 (leaving an unused portion of the standard television video frame 405). This approach maintains the resolution in the horizontal direction of the panorama at the expense of the resolution in the vertical direction.

In the case of an annular image, because the information of the annular image is less towards the center of the annular image than at the outer edge (and equivalently in the panoramic image version of the annular image), this approach can result in a loss of information in the vertical direction. Images from wide-angle lenses can also have distortions that affect the amount of information available to parts of an image and can have corresponding affects when the image is packed within the standard television video frame 400.

One skilled in the art will understand that while the warped representation can first be mapped (for example, by unwrapping an annular image) into a panorama and the panoramic image then scaled to fit into the standard television video frame 400, the transformation from the warped representation to the standard television video frame 400 can also include the required scaling.

FIG. 4B illustrates another way that a 4:1 aspect ratio panoramic image frame can be apportioned into a standard television video frame 410. In this example, each half of the panoramic image is packed into the standard television video frame 410 by scaling the dimension when performing the transformation while maintaining the vertical dimension. In this example, when each half of the panoramic image is transformed into the standard television video frame 410 the transformation scales the horizontal dimension of the half panoramic representation so that both halves of the panoramic image (for example, a first scaled 180-degree portion of the annular image 411 and a second scaled 180-degree portion of the annular image 413) will fit in the standard television video frame 410 (leaving an unused portion of the standard television video frame 415). This approach maintains the information in the vertical direction of the panorama at the expense of the information in the horizontal direction.

FIG. 4C illustrates how a 3.4:1 aspect ratio frame can be packed into a standard television video frame 420. In this example, when each half of the panoramic image is transformed into the standard television video frame 420, the transformation scales the vertical dimension of the half panoramic image so that both halves of the panoramic image (for example, a first scaled 180-degree portion of the annular image 421 and a second scaled 180-degree portion of the annular image 423) will fit in the standard television video frame 420 (leaving an unused portion of the standard television video frame 425). This approach maintains the information in the horizontal direction of the panorama at the expense of the information in the vertical direction. Thus, for annular images this approach further reduces the available resolution in the vertical dimension.

FIG. 4D illustrates another way that a 3.4:1 aspect ratio frame can be packed into a standard television video frame 430. In this example, each half of the panoramic image is packed into the standard television video frame 430 by scaling the horizontal dimension when performing the transformation while maintaining the vertical dimension. In this example, when each half of the panoramic image is transformed into the standard television video frame 430 the transformation scales the horizontal dimension of the half panoramic image so that both halves of the panoramic image (a first scaled 180-degree portion of the panoramic image 431 and a second scaled 180-degree portion of the panoramic image 433) will fit in the standard television video frame 430. This approach maintains the information in the vertical direction of the panorama at the expense of the information in the horizontal direction. Thus, this approach is often preferred when used with annular images because it tends to maintain the resolution in the vertical direction. In addition, substantially all of the standard television video frame 430 is packed with panoramic information.

The examples provided by FIG. 4A through FIG. 4D allow for transmitting immersive video frames using standard television broadcast infrastructure at the standard television frame rate (typically 30 frames-per-second). Often a frame rate of 15 fps is satisfactory for presentation of an immersive video. In this circumstance, the warped image can be transformed into two standard television video frames. FIG. 4E illustrates a pair of standard television video frames 440 (a first standard television video frame 441 and a second standard television video frame 443) for transmitting the warped representation. The first standard television video frame 441L contains a first 180-degree portion of the panoramic image 445 and the second standard television video frame 443 contains the second 180-degree portion of the panoramic image 447. Each standard television video frame contains an unused portion of the standard television video frame 449. In addition, each standard television video frame contains a portion that tags whether that frame is a first partial frame or a second partial frame. Thus, a first indicator portion 451 identifies the first standard television video frame 441 to be the first partial frame while a second indicator portion 453 identifies the second standard television video frame 443 to be the second partial frame. In addition, each partial frame can include a designated portion that contains other information (for example, a first ancillary data portion 455 and a second ancillary data portion 457). The first ancillary data portion 455 can be used to pass additional information from the remote site to the broadcast facility. This information can be sent as text for display, or as binary information encoded into the frame. One skilled in the art will understand that the first indicator portion 451 and the second indicator portion 453 are generally positioned in substantially the same area of their respective standard television video frame (although this condition is not required). The first indicator portion 451 and the second indicator portion 453 are used to indicate frame ordering.

One skilled in the art will understand that techniques similar to the above can be applied to sequencing more than two frames.

Other header or tag information can be included in the ancillary data portion of the frame. This can include the size and orientation of partial frames; how many television frames are used to assemble a panoramic frame; lens characteristics; error detection and correction codes; a frame rate value (so we can transmit sources in non-real-time or sources whose rate is not divisible by 30 fps (for example for PAL use (25 fps)).

Future high-resolution cameras will allow higher resolution immersive video frames (resulting in a panoramic image of 1920×480 pixels). These higher resolution frames can be packed into three standard video frames of 670×480 to provide a frame rate of 10 frames per second.

Where the warped image is obtained from one or more wide-angle lenses, the data making up the captured circular images can be equivalent to a panorama having a 2:1 ratio. Scaling can be applied to the 2:1 panoramic view to pack the information into at least one standard television video frame as previously discussed. In addition, the hemispherical information can be stored in a standard television video frame as is without prior mapping to a panorama.

FIG. 4F illustrates a television frame containing scaled hemispherical images 460. As previously discussed with respect to FIG. 2E and FIG. 2F two hemispherical images of a scene can be used to capture 360-degree by 180-degree information suitable for use in an immersive video. The television frame containing scaled hemispherical images 460 contains a first scaled hemispherical image 461 and a second scaled hemispherical image 463. Each of these images is scaled in the horizontal dimension (with respect to the frame) so that the two images can fit within the standard television video frame 460. The scaling of each image can be accomplished to retain the maximum amount of information (for example, by rotating the hemispherical image to maximize the retained information along the horizon line of the image).

FIG. 4G illustrates a pair of standard television video frames 470 that contain unscaled or uniformly scaled hemispherical images. The pair of standard television video frames 470 includes a first standard television video frame 471 and a second standard television video frame 473 that contain a first hemispherical image 475 and a second hemispherical image 477 respectively along with an unused portion 479. Similar to the frames described with respect to FIG. 4E, the pair of standard television video frames 470 includes a first indicator portion 481, a second indicator portion 483, a first ancillary data portion 485, and a second ancillary data portion 487 having similar functions as described with respect to FIG. 4E.

FIG. 4H illustrates a television frame 490 containing a truncated hemispherical image 491 that maximizes the information in the width direction and reduces an unused space 493 in the television frame 490 by sacrificing information in the vertical direction of the television frame 490. The truncated hemispherical image 491 can result from a wide-angle lens (including a fisheye lens). The truncated hemispherical image 491 can also be treated as a warped, limited-angle panorama (as compared to the previously discussed panoramas that can extend for substantially 360-degrees). Thus, the television frame 490 contains a higher resolution, limited-angle panorama that still allows generation of a user-specified view into the panorama as is subsequently described.

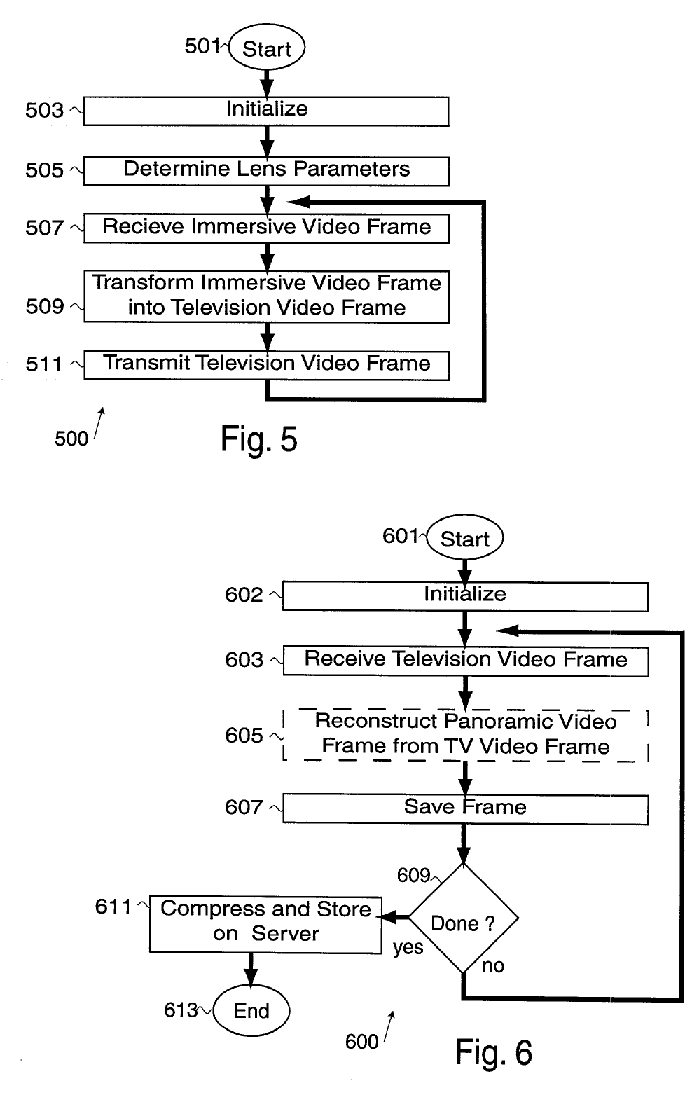

FIG. 5 illustrates an immersive video transmission process 500 that initiates at a ‘start’ terminal 501 and continues to an ‘initialization’ procedure 503 that performs any initialization in preparation for transmitting an immersive video from the remote broadcast unit 305 to the broadcast facility 313. After initialization, the immersive video transmission process 500 continues to a ‘determine lens parameters’ procedure 505 that determines the characteristics of the warping lens 303 or lenses. Some of these characteristics can include the field-of-view, number of lenses and exposure information. This information can be determined from the images received by the video camera 301, by prompting an operator for input, or by use of other mechanisms.

Once the lens parameters are determined, a ‘receive immersive video frame’ procedure 507 receives an immersive video frame from a stream of immersive video frames from the video camera 301 or playback unit (for example, a recorder/player or a storage device). A ‘transform immersive video frame’ procedure 509 apportions the received immersive video frame into at least one standard television video frame. This standard television video frame is transmitted to the broadcast facility 313 by a ‘transmit video frame’ procedure 511. The immersive video transmission process 500 continues to the ‘receive immersive video frame’ procedure 507 to process the next video frame received by the video camera 301. This process continues until there are no more immersive video frames to be received or until terminated by some condition (for example, termination by an operator).

FIG. 6 illustrates an immersive video receiver process 600 that initiates at a ‘start’ terminal 601 and continues to an ‘initialization’ procedure 602 that performs any initialization in preparation for receiving the at least one standard television video frame of an immersive video sent by the ‘transmit video frame’ procedure 511 of FIG. 5. After initialization, a ‘receive video frame’ procedure 603 receives a standard television video frame that contains information representing the immersive video frame captured by the video camera 301.

In some embodiments, a ‘reconstruct immersive video frame’ procedure 605 extracts each portion of the immersive video frame and regenerates the original panorama in memory. The regenerated panorama can be the same scale as the original panorama, but need not be.

Other embodiments, that can serve the immersive video from the standard television video frame, need not perform the ‘reconstruct immersive video frame’ procedure 605 because the server and/or client software are enabled to process the immersive video directly form the information in the standard television video frame without need for an intermediate regenerated panorama.

A ‘save frame’ procedure 607 stores the information received by the ‘receive video frame’ procedure 603 in computer memory, hard disk, or (when storing the received video frame) on videotape or other video storage mechanism. Once the frame is stored, the immersive video receiver process 600 continues to a ‘video complete’ decision procedure 609 that determines whether the video stream has ended or whether the immersive video receiver process 600 has been terminated. If the video stream has not ended, the immersive video receiver process 600 continues back to the ‘receive video frame’ procedure 603 to process the next frame. However, if the ‘video complete’ decision procedure 609 determines that the video stream has completed or that the process is to end, the immersive video receiver process 600 continues to a ‘compress and store video’ procedure 611. The ‘compress and store video’ procedure 611 can compress the received video and stores either or both the uncompressed and compressed streams. This compression is accomplished by a codec device or codec software executing within a computer.

Once the video is stored, the immersive video receiver process 600 terminates through an ‘end’ terminal 613.

One skilled in the art will understand that the immersive video receiver process 600 as previously described accumulates all the video frames before compressing them. Such a one will understand that other preferred embodiments allow (for example) every frame to be individually compressed, allow key frames to be compressed with subsequent non-key frames including difference information, or use streaming compression. These compression mechanisms can operate (for example, but without limitation) after all the frames have been received, in parallel as each frame is received, or in parallel on a set of received frames. Furthermore, although compression will generally be used, it is not required to practice the invention.

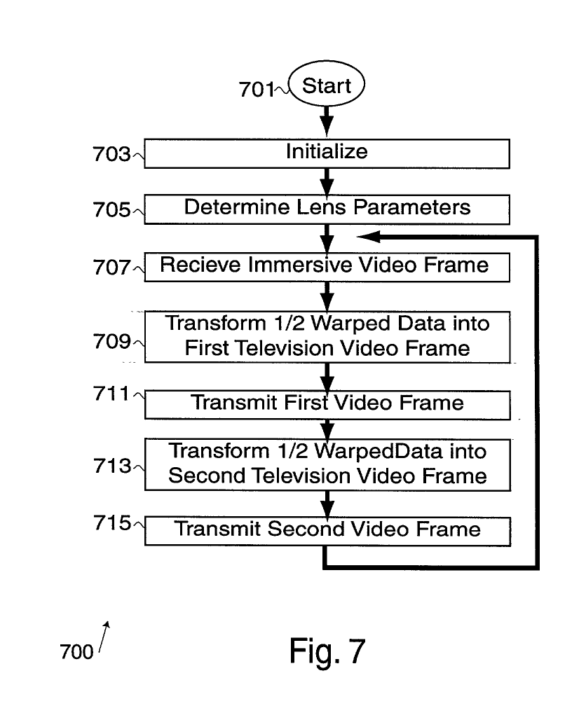

FIG. 7 illustrates an immersive video transmission process 700 that initiates at a ‘start’ terminal 701 and continues to an ‘initialize’ procedure 703 that performs any initialization in preparation for transmitting an immersive video from the remote broadcast unit 305 to the broadcast facility 313. After initialization, the immersive video transmission process 700 continues to a ‘determine lens parameters’ procedure 705 that determines the characteristics of the warping lens 303 or lenses. Some of these characteristics can include the field-of-view, number of lenses and exposure information. This information can be determined from the images received by the video camera 301, by prompting an operator for input, or by use of other mechanisms.

Once the lens parameters are determined, a ‘receive immersive video frame’ procedure 707 receives a warped representation from a stream of immersive video frames from the video camera 301. A ‘transform ½ immersive video into first video frame’ procedure 709 transforms substantially half of the warped representation (if the video frame contains an annular image, half of the annular image is unwrapped) into a standard television video frame and marks the standard television video frame as a first partial frame by filling the first indicator portion 451 with a first identified signal such as a “white” color. The standard television video frame is then transmitted by the ‘transmit first video frame’ procedure 711. If the half panorama fits with the standard television video frame, it need not be scaled.

The second portion of the warped representation is transformed by the ‘transform ½ immersive video into second video frame’ procedure 713 into a standard television video frame and marks the standard television video frame as a second partial frame by the second indicator portion 453 with a “black” color. The standard television video frame is then transmitted by a ‘transmit second video frame’ procedure 715.

After the second partial frame is transmitted by the ‘transmit second video frame’ procedure 715 the immersive video transmission process 700 continues to the ‘receive immersive video frame’ procedure 707 to receive and process the next warped representation. The process continues until no additional immersive video frames are received by the ‘receive immersive video frame’ procedure 707 or until an event occurs (such as termination by an operator).

One skilled in the art will understand that the first partial frame and the second partial frame are distinguished by differences between values in the first indicator portion 451 and the second indicator portion 453. Such a one will also understand that the “white” and “black” colors only need to be distinguishable such that the receiver can determine which of standard television video frame is the first partial frame and which is the second partial frame. In addition, such a one will understand that additional information can be included in the first ancillary data portion 455 and/or the second ancillary data portion 457 as the standard television video frame is being constructed. Finally, such a one will understand that the previously described techniques can be applied to more than two standard television video frames so long as the resulting immersive video frame rate is satisfactory.

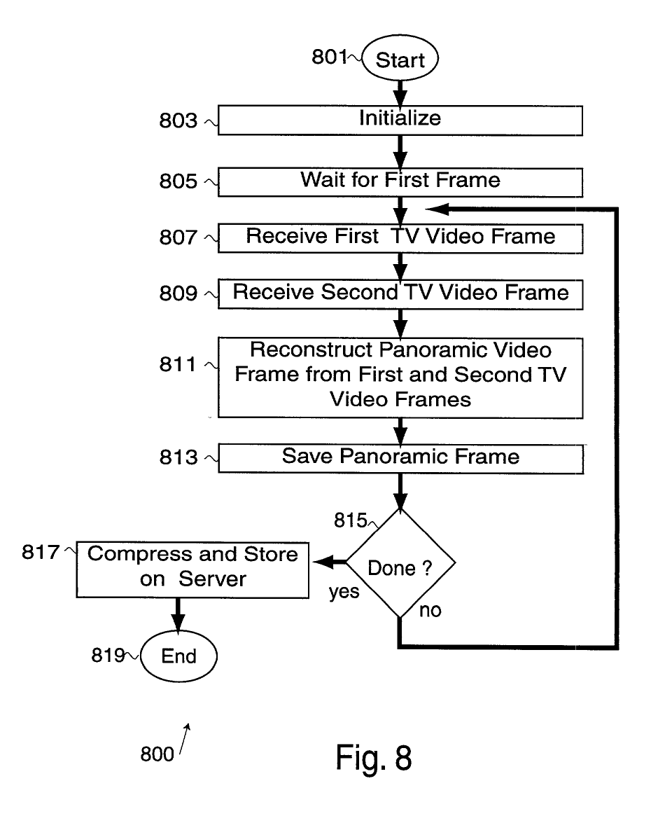

FIG. 8 illustrates an immersive video receiver process 800 that initiates at a ‘start’ terminal 801 and initializes at an ‘initialize’ procedure 803. Once the immersive video receiver process 800 has initialized, it continues to a ‘wait for first frame’ procedure 805 that receives frames sent using the immersive video transmission process 700 of FIG. 7 until it detects a first partial frame by examining the indicator portion of the standard television video frame for the first indicator portion 451. Next, the immersive video receiver process 800 continues to a ‘receive first video frame’ procedure 807 that receives the standard television video frame that contains the first partial frame. A ‘receive second video frame’ procedure 809 then receives the standard television video frame that contains the second partial frame. Once both partial frames are received, a ‘reconstruct immersive video frame’ procedure 811 assembles the partial frames into a panoramic video frame that is saved by the ‘save immersive video frame’ procedure 813. Furthermore, the ‘reconstruct immersive video frame’ procedure 811 can extract information stored in the first ancillary data portion 455 and/or the second ancillary data portion 457.

One skilled in the art will understand that the assembly process can start on information received in the first video frame once the first video frame is received.

A ‘video complete’ decision procedure 815 determines whether the immersive video has completed. If not, the immersive video receiver process 800 continues to the ‘receive first video frame’ procedure 807 (some embodiments—those that have the possibility of losing synchronization—can return to the ‘wait for first frame’ procedure 805) to receive and process the next first partial frame and second partial frame.

Once the panoramic frames are saved, a ‘compress and store video on server’ procedure 817 optionally compresses the video frames and stores the compressed or non-compressed frames on a server. The immersive video receiver process 800 completes through an ‘end’ terminal 819

One skilled in the art will understand that the immersive video receiver process 800 as previously described accumulates all the video frames before compressing them. The invention was described in such a way as to make it more understandable. Such a one will understand that other embodiments allow every frame to be individually compressed, allow key frames to be compressed with subsequent non-key frames including difference information. These compression mechanisms can operate (for example, but without limitation) after all the frames have been received, in parallel as each frame is received, or in parallel on a set of received frames. In addition, one skilled in the art will understand that the functions of the immersive video receiver process 600 and the immersive video receiver process 800 can be combined to automatically detect whether partial frames or complete frames are being received.

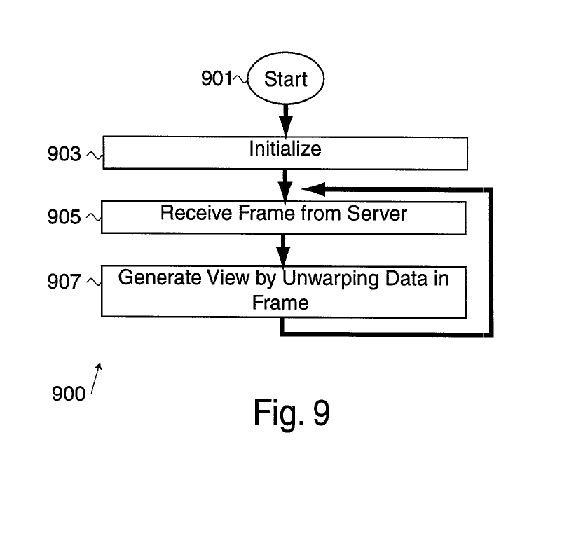

FIG. 9 illustrates a viewing process 900 that initiates at a ‘start’ terminal 901 and initializes at an ‘initialize’ procedure 903. The viewing process 900 continues to a ‘receive frame from server’ procedure 905 (for example, but without limitation, by using techniques such as those described in U.S. Pat. No. 6,043,837). Once the frame is received, data from within the frame is unwarped to generate a view according to a user-specified viewpoint (for example, but without limitation, by using techniques such as those described in U.S. Pat. No. 5,796,426). The view can be displayed for example on a computer monitor, a television, by being printed on a tangible media or otherwise presented to a viewer. In addition, the view can be recorded on optically sensitive film, a disk (such as a magnetic disk, CD or DVD), a videotape, or other tangible recording media.

One skilled in the art will understand that the one embodiment of the invention allows immersive video frames to be sent from a remote site to a receiving site using standard television infrastructure. Such a one will also understand that some of the many uses of the invention include live broadcast of sporting events, newscasts, and any other situation where a real-time immersive video is to be transferred from the remote broadcast unit 305 to the broadcast facility 313. Once at the broadcast facility 313 the immersive video can be compressed and provided for distribution to others by transmission from the broadcast facility 313 for viewer control on a set-top-box, by storage on a server for access over a computer network for viewer control on a computer, by selecting a view from the immersive video at the broadcast facility 313 for separate broadcast or picture-in-picture inclusion within an existing broadcast.

From the foregoing, it will be appreciated that the invention has (without limitation) the following advantages:

1) Removes the need for expensive codec devices at the camera site.

2) Uses existing television transmission infrastructure to send an immersive video from the camera site to a central site.

3) Removes the need for a high-data-rate communication link at the camera site.

4) Removes the need for high-speed network connections between the remote broadcast unit 305 and the broadcast facility 313.

5) Removes the need for streaming video expertise at the remote site as the streaming is done at the studio.

Although the present invention has been described in terms of the presently preferred embodiments, one skilled in the art will understand that various modifications and alterations may be made without departing from the scope of the invention. Accordingly, the scope of the invention is not to be limited to the particular invention embodiments discussed herein.

What is claimed is:

1. A method comprising steps of:
acquiring one of a plurality of immersive video frames at a first location, said one of said plurality of immersive video frames a portion of an immersive video;
packing said one of said plurality of immersive video frames into at least one standard television video frame; and
sending, from said first location, said at least one standard television video frame capable of being received at a second location using a television signal transmission mechanism.

2. A method comprising steps of:
acquiring one of a plurality of immersive video frames at a first location, wherein said one of said plurality of immersive video frames contains a warped representation of a scene and is a portion of an immersive video;
packing said one of said plurality of immersive video frames into at least one standard television video frame;
sending, from said first location, said at least one standard television video frame to a second location using a television signal transmission mechanism;
receiving, by a television signal receiver mechanism at said second location, said at least one standard television video frame;
unwarping a portion of said at least one standard television video frame into a view; and
presenting said view.

3. A method comprising steps of:
receiving at least one standard television video frame containing one of a plurality of immersive video frames, by a television signal receiver mechanism;
unwarping a portion of said at least one standard television video frame into a view; and
presenting said view.

4. The method of claim 1 or 2 wherein the steps of acquiring, packing, and sending are repeated with a second one of said plurality of immersive video frames.

5. The method of claim 1 further comprising receiving said at least one standard television video frame by a television signal receiver mechanism at said second location.

6. The method of claim 5 further comprising steps of:
unwarping a portion of said at least one standard television video frame into a view; and
presenting said view.

7. The method of claim 1 or 2 wherein the step of packing comprises steps of:
unwrapping an annular image contained within said one of said plurality of immersive video frames; and
scaling said unwrapped annular image to fit within said at least one standard television video frame.

8. The method of claim 1 wherein said one of said plurality of immersive video frames contains a warped representation of a scene.

9. The method of claim 2 or 8 wherein said warped representation results from capturing said scene through a catadioptric lens.

10. The method of claim 2 or 8 wherein said warped representation results from capturing said scene through at least one wide-angle lens.

11. The method of claim 2 or 8 wherein said warped representation results from capturing said scene through at least one fish-eye lens.

12. The method of claim 2, 3 or 6 wherein the step of presenting comprises a step of recording said view on a videotape, a disk, an optical film or other tangible recording media.

13. The method of claim 2, 3 or 6 wherein the step of presenting comprises a step of displaying said view on a television, a computer monitor, or on a tangible media.

14. The method of claim 2, 3 or 6 further comprising steps of:
reconstructing said one of said plurality of immersive video frames from said at least one standard television video frame;
compressing said one of said plurality of immersive video frames into a compressed frame;
storing said compressed frame in a server computer; and
serving said compressed frame from said server computer to a client device;
wherein the step of unwarping is performed at said client device.

15. The method of claim 14 wherein said client device is selected from the group consisting of a client computer, a television receiver, a video conferencing receiver, a personal organizer, a set-top-box, and an entertainment system.

16. The method of claim 14 wherein the step of serving sends said compressed frame to said client device using a transmission mechanism selected from the group consisting of a microwave link, a television cable system, a direct subscriber line (DSL) system, a satellite communication system, a fiber communication system, an Internet, a digital television system, an analog television system, a wire system and a wireless system.

17. The method of claim 1 or 2 wherein the step of packing further comprises steps of:
apportioning said one of said plurality of immersive video frames into a plurality of portions;
scaling one or more of said plurality of portions; and
storing each of said scaled plurality of portions in one of said at least one standard television video frame.

18. The method of claim 1 or 2 wherein the step of packing further comprises steps of:
tagging said first of said at least one standard television video frame as a first partial frame; and
tagging said second of said at least one standard television video frame as a second partial frame.

19. The method of claim 18 further comprising steps of:
mapping a first portion of said one of said plurality of immersive video frames into a first of said at least one standard television video frame; and
mapping a second portion of said one of said plurality of immersive video frames into a second of said at least one standard television video frame.

20. The method of claim 1 or 2 wherein the step of acquiring acquires said plurality of immersive video frames from a digital video camera, an analog video camera in communication with a digitizer, a video playback device, or a computer.

21. An apparatus comprising:
an acquisition mechanism configured to acquire one of a plurality of immersive video frames at a first location, said one of said plurality of immersive video frames a portion of an immersive video;
a packing mechanism configured to pack said one of said plurality of immersive video frames received by the acquisition mechanism into at least one standard television video frame; and
a sending mechanism configured to send, from said first location, said at least one standard television video frame capable of being received at a second location using a television signal transmission mechanism, said at least one standard television video frame packed by the packing mechanism.

22. A system comprising:
an acquisition mechanism configured to acquire one of a plurality of immersive video frames at a first location, wherein said one of said plurality of immersive video frames contains a warped representation of a scene and is a portion of an immersive video;
a packing mechanism configured to pack said one of said plurality of immersive video frames acquired by the acquisition mechanism into at least one standard television video frame;
a sending mechanism configured to send from said first location, said at least one standard television video frame to a second location using a television signal transmission mechanism, said at least one standard television video frame responsive to the packing mechanism;
a television signal receiver mechanism at said second location configured to receive said at least one standard television video frame sent by the sending mechanism;
a transformation mechanism configured to unwarp a portion of said at least one standard television video frame received by the television signal receiver mechanism into a view; and
a presentation mechanism configured to present said view as transformed by the transformation mechanism.

23. An apparatus comprising:
a television signal receiver mechanism configured to receive at least one standard television video frame containing one of a plurality of immersive video frames;
a transformation mechanism configured to unwarp a portion of said at least one standard television video frame received by the television signal receiver mechanism into a view; and
a presentation mechanism configured to present said view as transformed by the transformation mechanism.

24. The apparatus of claim 21 or 22 wherein the packing mechanism further comprises:
a mapping mechanism configured to map an annular image contained within said one of said plurality of immersive video frames; and
a scaling mechanism configured to scale said mapped annular image to fit within said at least one standard television video frame.

25. The apparatus of claim 21 wherein said one of said plurality of immersive video frames contains a warped representation of a scene.

26. The apparatus of claim 22 or 25 wherein said warped representation results from capturing said scene through a catadioptric lens.

27. The apparatus of claim 22 or 25 wherein said warped representation results from capturing said scene through at least one wide-angle lens.

28. The apparatus of claim 22 or 25 wherein said warped representation results from capturing said scene through at least one fish-eye lens.

29. The apparatus of claim 22 or 23 wherein the presentation mechanism comprises a recording mechanism configured to record said view on a videotape, a disk, an optical film or other tangible recording media.

30. The apparatus of claim 22 or 23 wherein the presentation mechanism comprises a display mechanism configured to display said view on a television, a computer monitor, or on a tangible media.

31. The apparatus of claim 22 or 23 further comprising:
a reconstruction mechanism configured to reconstruct said one of said plurality of immersive video frames from said at least one standard television video frame;
a compression mechanism configured to compress said one of said plurality of immersive video frames into a compressed frame;
a storage mechanism configured to store said compressed frame in a server computer; and
a server mechanism configured to serve said compressed frame from said server computer to a client device;
wherein the transformation mechanism is located at said client device.

32. The apparatus of claim 31 wherein said client device is selected from the group consisting of a client computer, a television receiver, a video conferencing receiver, a personal organizer, a set-top-box, and an entertainment system.

33. The apparatus of claim 31 wherein the server mechanism is configured to send said compressed frame to said client device using a transmission mechanism selected from the group consisting of a microwave link, a television cable system, a direct subscriber line (DSL) system, a satellite communication system, a fiber communication system, an Internet, a digital television system, an analog television system, a wire system and a wireless system.

34. The apparatus of claim 21 or 22 wherein the packing mechanism further comprises:
an apportionment mechanism configured to apportion said one of said plurality of immersive video frames into a plurality of portions;
a scaling mechanism, responsive to the apportionment mechanism, configured to scale one or more of said plurality of portions; and
a portion storage mechanism configured to store each of said scaled plurality of portions in one of said at least one standard television video frame.

35. The apparatus of claim 21 or 22 wherein the packing mechanism further comprises:
a tag mechanism configured to tag said first of said at least one standard television video frame as a first partial frame and said second of said at least one standard television video frame as a second partial frame.

36. The apparatus of claim 35 further comprising:
a mapping mechanism configured to map a first portion of said one of said plurality of immersive video frames into a first of said at least one standard television video frame and a second portion of said one of said plurality of immersive video frames into a second of said at least one standard television video frame.

37. The apparatus of claim 21 or 22 wherein the acquisition mechanism acquires said plurality of immersive video frames from a digital video camera, an analog video camera in communication with a digitizer, a video playback device, or a computer.

38. A computer program product comprising:
a computer usable data carrier having computer readable code embodied therein for causing a computer to send one of a plurality of immersive video frames, said computer readable code comprising:
computer readable program code configured to cause said computer to effect a packing mechanism configured to pack said one of said plurality of immersive video frames capable of being received by an acquisition mechanism at a first location into at least one standard television video frame, said one of said plurality of immersive video frames a portion of an immersive video; and
computer readable program code configured to cause said computer to effect a sending mechanism configured to send, from said first location, said at least one standard television video frame capable of being received at a second location using a television signal transmission mechanism, said at least one standard television video frame packed by the packing mechanism.

39. The computer program product of claim 38 wherein the packing mechanism further comprises:
computer readable program code configured to cause said computer to effect a mapping mechanism configured to unwrap an annular image contained within said one of said plurality of immersive video frames; and
computer readable program code configured to cause said computer to effect a scaling mechanism configured to scale said unwrapped annular image to fit within said at least one standard television video frame.

40. The computer program product of claim 38 wherein the packing mechanism further comprises:
computer readable program code configured to cause said computer to effect an apportionment mechanism configured to apportion said one of said plurality of immersive video frames into a plurality of portions;
computer readable program code configured to cause said computer to effect a scaling mechanism, responsive to the apportionment mechanism, configured to scale one or more of said plurality of portions; and
computer readable program code configured to cause said computer to effect a portion storage mechanism configured to store each of said scaled plurality of portions in one of said at least one standard television video frame.

41. The computer program product of claim 38 wherein the packing mechanism further comprises computer readable program code configured to cause said computer to effect a tag mechanism configured to tag said first of said at least one standard television video frame as a first partial frame and said second of said at least one standard television video frame as a second partial frame.

42. The computer program product of claim 41 further comprising computer readable program code configured to cause said computer to effect a mapping mechanism configured to map a first portion of said one of said plurality of immersive video frames into a first of said at least one standard television video frame and a second portion of said one of said plurality of immersive video frames into a second of said at least one standard television video frame.

43. The computer program product of claim 38 wherein the acquisition mechanism is capable of acquiring said plurality of immersive video frames from a digital video camera, an analog video camera in communication with a digitizer, a video playback device, or a computer.

44. The computer program product of claim 38 wherein said one of said plurality of immersive video frames contains a warped representation of a scene.

45. The computer program product of claim 44 wherein said warped representation results from capturing said scene through a catadioptric lens.

46. The computer program product of claim or 44 wherein said warped representation results from capturing said scene through at least one wide-angle lens.

47. The computer program product of claim 44 wherein said warped representation results from capturing said scene through at least one fish-eye lens.

48. A computer program product comprising:
a computer usable data carrier having computer readable code embodied therein for causing a computer to present one of a plurality of immersive video frames, said computer readable code comprising:
computer readable program code configured to cause said computer to effect a transformation mechanism configured to unwarp a portion of said one of said plurality of immersive video frames contained in at least one standard television video frame received by a television signal receiver mechanism into a view, said at least one standard television video frame, containing one of said plurality of immersive video frames; and
computer readable program code configured to cause said computer to effect a presentation mechanism configured to present said view as transformed by the transformation mechanism.

49. The computer program product of claim 48 wherein the presentation mechanism comprises computer readable program code configured to cause said computer to effect a recording mechanism configured to record said view on a videotape, a disk, an optical film or other tangible recording media.

50. The computer program product of claim 48 wherein the presentation mechanism comprises computer readable program code configured to cause said computer to effect a display mechanism configured to display said view on a television, a computer monitor, or on a tangible media.

51. The computer program product of claim 48 further comprising:
computer readable program code configured to cause said computer to effect a reconstruction mechanism configured to reconstruct said one of said plurality of immersive video frames from said at least one standard television video frame;
computer readable program code configured to cause said computer to effect a compression mechanism configured to compress said one of said plurality of immersive video frames into a compressed frame;
computer readable program code configured to cause said computer to effect a storage mechanism configured to store said compressed frame in a server computer; and
computer readable program code configured to cause said computer to effect a server mechanism configured to serve said compressed frame from said server computer to a client device;
wherein the transformation mechanism is located at said client device.

52. The computer program product of claim 51 wherein said client device is selected from the group consisting of a client computer, a television receiver, a video conferencing receiver, a personal organizer, a set-top-box, and an entertainment system.

53. The computer program product of claim 51 wherein the server mechanism is configured to send said compressed frame to said client device using a transmission mechanism selected from the group consisting of a microwave link, a television cable system, a direct subscriber line (DSL) system, a satellite communication system, a fiber communication system, an Internet, a digital television system, an analog television system, a wire system and a wireless system.

54. A computer program product comprising of claim 38 or 48 wherein the computer usable data carrier is a computer readable media.

55. A computer program product comprising of claim 38 or 48 wherein the computer usable data carrier is a carrier wave.
